(19) United States
(12) Patent Application Publication
(10) Pub. No.: US 2021/0333902 A1
(43) Pub. Date: Oct. 28, 2021

(54) TOUCH DISPLAY DEVICE AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventors: Mingjun ZHOU, Shenzhen (CN); Zhenhua SHI, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,527

(22) PCT Filed: Dec. 6, 2019
(86) PCT No.: PCT/CN2019/123463

§ 371 Date: Dec. 25, 2019

(30) Foreign Application Priority Data
Oct. 12, 2019 (CN) 201910968646.1

(51) Int. Cl. G06F 3/041; B32B 7/14; B32B 37/12

(52) U.S. Cl. CPC G06F 3/041; B32B 7/14; B32B 37/1292; B32B 37/1207; B32B 2457/208; B32B 2037/1253; B32B 2037/1215; B32B 2310/08; B32B 2309/68; G06F 2203/04103

(57) ABSTRACT

A touch display device and a manufacturing method thereof are provided. During a panel bonding process, a display panel and a touch panel are adhered by a liquid optical clear adhesive using a full lamination technology. A cover is then adhered to the touch panel by a solid optically clear adhesive using a frame bonding technology to form a vacuum chamber. The cover, the touch panel, and the display panel in the formed touch display device are closely adhered to each other. Moreover, an optical adhesive material is effectively saved.

### CROSS REFERENCE TO RELATED APPLICATIONS

This application claims the priority of a Chinese Patent Application No. 201910968646.1, filed on Oct. 12, 2019, titled “TOUCH DISPLAY DEVICE AND MANUFACTURING METHOD THEREOF”, the entire contents of which are incorporated herein by reference.

### FIELD OF DISCLOSURE

The present application relates to the field of display technologies, and in particular, to a touch display device and a manufacturing method thereof.

### BACKGROUND

A touch panel (TP), also known as a touch screen, is a device that is formed on a display surface of an image display device and uses a conductor such as a human body or a capacitive pen for command input. It can replace external input devices such as mice, keyboards, mechanical input keys, and other input devices. It can effectively simplify a structure of electronic products such as computers, mobile phones, electronic meters, and gaming devices. It has a very broad application prospect. In terms of technical principles, the touch panel mainly includes capacitive, resistive, ultrasonic and infrared types.

An infrared touch technology with accurate touch accuracy and relatively low cost, currently occupies a large part of a touch market. However, the infrared touch technology is not suitable for places with strong light. If sunlight is directly irradiated on a touch surface, or if there are obstructions such as dust and water droplets, it will affect the accuracy of the touch. With advantages of capacitors, such as the gradual reduction in cost, larger size, high sensitivity, strong anti-interference ability, wide applications, and small impact on an appearance of a machine, etc., a capacitive touch technology is reflected in its relatively sensitive touch, which is used and sought by more and more users.

FIG. 1 is a schematic diagram of a layered structure of a touch display device in the prior art. The touch display device includes a display panel 11, a touch panel (TP) 13, and a cover glass (CG) 15 that are sequentially stacked. Adjacent components are bonded by a solid optically clear adhesive (SOCA) 19 using a full lamination technology.

In a field of commercial displays, as a large display device such as an educational whiteboard and a high-end conference machine, a large-sized touch display device is required for easy operation and presentation. For large-sized touch display devices, a use of full lamination technology requires a large amount of solid optically clear adhesive, which greatly increases a production cost and has undesirable phenomena such as debonding. Also, because the adjacent components are bonded by the solid optically clear adhesive using the full lamination technology, there will cause problems of bonding yellowing, bending due to different expansion and contraction, and wrinkling in a visible area.

### SUMMARY OF DISCLOSURE

In view of the problems existing in the prior art, an object of the present disclosure is to provide a touch display device and a manufacturing method thereof, which can use a small amount of optical adhesive to adopt a vacuum bonding method, so that a cover, a touch panel, and a display panel are closely adhered, thereby saving optical adhesive material and improving product yield.

In order to achieve the above object, the present disclosure provides a manufacturing method of a touch display device, including: providing a display panel; covering an upper surface of the display panel with a full-surface adhesive layer, where the full-surface adhesive layer includes a liquid optical clear adhesive; disposing a touch panel on the upper surface of the display panel, so that the touch panel corresponds to a middle of the display panel, and a lower surface of the touch panel is attached to an upper surface of the full-surface adhesive layer; attaching a first sub frame adhesive layer to an edge of an upper surface of the touch panel, where the first sub frame adhesive layer includes a liquid adhesive; cutting a solid optically clear adhesive into an adhesive strip and attaching the adhesive strip to an upper surface of the first sub frame adhesive layer, where a width of the adhesive strip is less than a width of the first sub frame adhesive layer; disposing a cover on the upper surface of the touch panel, so that the cover corresponds to a middle portion of the touch panel, and an upper surface of the adhesive strip is attached to a lower surface of the cover; heating the cover, the touch panel, and the display panel which are attached with the corresponding adhesive layer under a vacuum environment, so that the adhesive strip is melted; and irradiating the cover, the touch panel, and the display panel which are attached with the corresponding adhesive layer with ultraviolet ray under the vacuum environment such that the full-surface adhesive layer is cured, and the melted adhesive strip is cured into a second sub frame adhesive layer, and a vacuum chamber is formed on middle portions of the first sub frame adhesive layer and the second sub frame adhesive layer.

In order to achieve the above object, the present disclosure provides a touch display device, including a display panel, a full-surface adhesive layer, a touch panel, a frame adhesive layer, a vacuum chamber, and a cover. The full-surface adhesive layer covers an upper surface of the display panel. The touch panel is attached to an upper surface of the full-surface adhesive layer, where the touch panel corresponds to a middle portion of the display panel. The frame adhesive layer is attached to an edge of an upper surface of the touch panel. The vacuum chamber is formed on a middle portion of the frame adhesive layer. The cover is attached to an upper surface of the frame adhesive layer, where the cover corresponds to a middle portion of the touch panel.

In order to achieve the above object, the present disclosure also provides a manufacturing method of a touch display device, including: providing a display panel; covering an upper surface of the display panel with a full-surface adhesive layer; disposing a touch panel on the upper surface of the display panel, so that the touch panel corresponds to a middle portion of the display panel, and a lower surface of the touch panel is attached to an upper surface of the full-surface adhesive layer; attaching a frame adhesive layer to an edge of an upper surface of the touch panel; disposing a cover on the upper surface of the touch panel, so that the cover corresponds to a middle portion of the touch panel, and an upper surface of the frame adhesive layer is attached to a lower surface of the cover; and irradiating the cover, the touch panel, and the display panel which are attached with the corresponding adhesive layer with ultraviolet ray under a vacuum environment such that the full-surface adhesive layer and the frame adhesive layer are cured, and a vacuum chamber is formed on a middle portion of the frame adhesive layer.

In the present disclosure, during a panel bonding process, the display panel and the touch panel are adhered by the liquid optical clear adhesive using the full lamination technology. The cover is then adhered to the touch panel by the solid optically clear adhesive using the frame bonding technology to form the vacuum chamber. The cover, the touch panel, and the display panel in the formed touch display device are closely adhered to each other. Therefore, a flatness of a surface of a touch area is better, a sensitivity of touch operation is high, a touch experience is better. Also, an optical glue material is effectively saved, a production costs is reduced. It avoids problems such as bonding yellowing, different bending, and wrinkling in a visible area, thereby improving a product yield.

### BRIEF DESCRIPTION OF DRAWINGS

In order to explain technical solutions in embodiments of the present disclosure more clearly, drawings used in the description of the embodiments will be briefly introduced below. Apparently, the drawings in the following description are just some embodiments of the present disclosure. For those skilled in the art, other drawings can be obtained based on these drawings without creative efforts.

FIG. 1 is a schematic diagram of a layered structure of a touch display device in the prior art.

FIG. 2 is a schematic diagram of a layered structure of a touch display device of an embodiment of the present disclosure.

FIG. 3 is a schematic diagram of a layered structure of a touch display device of another embodiment of the present disclosure.

FIG. 4 is a flowchart of a manufacturing method of a touch display device of the present disclosure.

### DETAILED DESCRIPTION

The embodiments of the present disclosure will be described in detail below with reference to the accompanying drawings in which same or similar reference numerals indicate the same or similar elements, or elements with same or similar function. The embodiments described below with reference to the accompanying drawings are exemplary and are merely used to explain the present disclosure, but should not be construed as limiting the present disclosure.

Terms such as “first”, “second”, “third”, and etc. (if exists) in the specification, claims, and the aforementioned accompanying drawings are used to differentiate similar objects, and may not necessarily used to illustrate specific order or sequence. It should be understood that objects used in such way may be exchanged under proper situations. Furthermore, terms of “comprising” and “including” and any their derivatives are intended to cover non-excluding inclusions.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

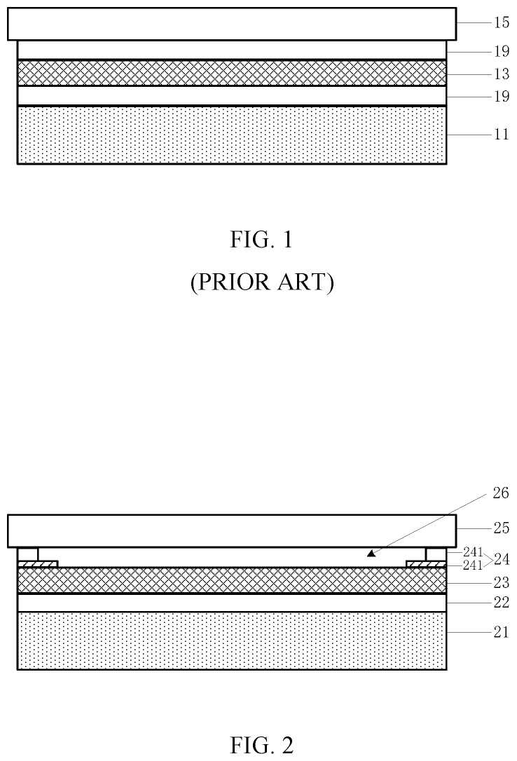

FIG. 2 is a schematic diagram of a layered structure of a touch display device of an embodiment of the present disclosure. In this embodiment, the touch display device includes a display panel 21, a touch panel 23, and a cover 25. The display panel 21 and the touch panel 23 are adhered through a full-surface adhesive layer 22. The cover 25 is adhered to the touch panel 23 through a frame adhesive layer 24, and a vacuum chamber 26 is formed between the touch panel 23 and the cover 25.

The display panel 21 may be a liquid crystal display (LCD) panel, an organic light emitting diode (OLED) display panel, an active-matrix organic light emitting diode (AMOLED) display panel, a quantum-dot light emitting diode (QLED) display panel, and the like. The display panel 21 is configured to provide an image for the touch display device.

The touch panel 23 is attached to an upper surface of the display panel 21 and is disposed corresponding to a middle portion of the display panel 21. In a further embodiment, a shape and size of the touch panel 23 are the same as that of the display panel 21, so that an operation area of the touch panel 23 being consistent with a display area of the display panel 21 can be effectively ensured.

The full-surface adhesive layer 22 covers an upper surface of the display panel 21, and a lower surface of the touch panel 23 is attached to an upper surface of the full-surface adhesive layer 22, so that the touch panel 23 is adhered to the display panel 21.

In a further embodiment, the full-surface adhesive layer 22 may be a liquid optical clear adhesive (LOCA). The LOCA is a special adhesive used for the bonding of transparent optical elements. It is transparent with a light transmittance of more than 98%, which can ensure accurate color and sufficient display brightness. Also, it has good bonding strength, can be cured at normal or medium temperature, and has the characteristics of small curing shrinking percentage and yellowing resistance. Since the full-surface adhesive layer 22 uses a liquid optical clear adhesive, and fully covers the upper surface of the display panel 21, the touch panel 23 and the display panel 21 can be bonded by the liquid optical clear adhesive using a full lamination technology. The cover component using the full lamination technology has better surface flatness of a touch area, higher sensitivity of touch operation, and better touch experience.

The cover 25 is attached to the upper surface of the touch panel 23, and the cover 25 is disposed corresponding to a middle portion of the touch panel 23. The cover 25 is used to protect the touch panel 23 and the display panel 21, and a user can directly perform touch operations on the cover 25. Preferably, a surface area of the cover 25 is larger than a surface area of the touch panel 23, so that the cover 25 can cover a full-surface of the touch panel 23, so that a touch operation performed by the user on the cover 25 has good sensitivity, and it is beneficial to achieving a narrow bezel design. The cover 25 is preferably a cover glass.

The frame adhesive layer 24 is attached to an edge of an upper surface of the touch panel 23, and the cover 25 is attached to an upper surface of the frame adhesive layer 24 so that the cover 25 and the touch panel 23 are attached. The vacuum chamber 26 is formed in a middle portion of the frame adhesive layer 24. Since the middle portion of the touch panel 23 and the middle portion of the cover 25 form a vacuum, and they are attached to each other under the effect of atmospheric pressure, a space occupied by the vacuum chamber 26 is compressed to a minimum, so that the cover 25 and the touch panel 23 can be closely attached together. Therefore, the operation of the user on the cover 25 that completely covers the touch panel 23 has good sensitivity.

In a further embodiment, the frame adhesive layer 24 may be a solid optically clear adhesive (SOCA). The solid optically clear adhesive can be melted under heating conditions and can be cured under UV light irradiation. Because the frame adhesive layer 24 uses a solid optically clear adhesive and is attached to the edge of the upper surface of the touch panel 23, the cover 25 and the touch panel 23 can be bonded by the solid optically clear adhesive using a frame bonding technology. Because a large amount of optical glue is required in the full lamination technology, which greatly increases a manufacturing cost of the panel, the frame bonding technology is adopted between the cover 25 and the touch panel 23 to effectively save the optical adhesive material.

In a further embodiment, the frame adhesive layer 24 includes a first sub frame adhesive layer 241 and a second sub frame adhesive layer 242. The first sub frame adhesive layer 241 is attached to the edge of the upper surface of the touch panel 23. The second sub frame adhesive layer 242 is attached to an upper surface of the first sub frame adhesive layer 241. The cover 25 is attached to an upper surface of the second sub frame adhesive layer 242, so that the cover 25 and the touch panel 23 are adhered to each other. The vacuum chamber 26 is formed in middle portions of the first sub frame adhesive layer 241 and the second sub frame adhesive layer 242.

In a further embodiment, the first sub frame adhesive layer 241 uses an adhesive with high adhesion, and plays a role of pre-fixing and positioning for the second sub frame adhesive layer 242 to prevent the second sub frame adhesive layer 242 from being misaligned. The first sub frame adhesive layer 241 may be a liquid adhesive or a solid adhesive, as long as the second sub frame adhesive layer 242 can be closely attached to the first sub frame adhesive layer 241, the positions of the second sub frame adhesive layer 242 and the first sub frame adhesive layer 241 can be consistent. The second sub frame adhesive layer 242 is a solid optically clear adhesive. A width of the second sub frame adhesive layer 242 is less than or equal to a width of the first sub frame adhesive layer 241. It is convenient for the second sub frame adhesive layer 242 to be attached to an upper surface of the first sub frame adhesive layer 241. It avoids that the second sub frame adhesive layer 242 is misaligned or peeled off. FIG. 2 is used to illustrate a positional relationship of each component. In fact, by vacuuming and heating to melt and cure the UV-curable adhesive layer, the middle portion of the cover 25 and the middle portion of the touch panel 23 are attached to each other under the action of atmospheric pressure, and the space occupied by the vacuum chamber 26 is compressed to a minimum, effectively ensuring the sensitivity of the touch operation.

An uncured optical adhesive has extremely low adhesion, especially when implementing a narrow bezel display panel design, if the optical adhesive is directly attached to the upper surface of the touch panel 23, the optical adhesive is easily misaligned. During the curing process of the optical adhesive, the cover 25 and the touch panel 23 cannot be closely adhered, which further affects a quality of the display panel. A cured optical adhesive has excellent weather resistance, especially excellent anti-spread and anti-explosive properties, which greatly improves the safety, reliability, durability, and aesthetics of the display field, with high light absorption, high bonding strength, low haze, low shrinkage, and yellowing resistance, etc. It is mainly suitable for full-lamination fields such as medium and large-sized computers, liquid crystal displays, and all-in-one computers. Therefore, a layer of the first sub frame adhesive layer 241 with high adhesion is attached in advance on the upper surface of the touch panel 23 to prevent the second sub frame adhesive layer 242 made of a narrow solid optically clear adhesive material misaligned and peeled off, which avoids hidden safety hazards and inaccurate alignment problems.

In a further embodiment, a shape of the second sub frame adhesive layer 242 is a ring-shaped, so that when the cover 25 and the touch panel 23 are bonded using the frame bonding technology, they can be closely bonded. Because the shape of the second sub frame adhesive layer 242 is ring-shaped, a shape of the first sub frame adhesive layer 241 is preferably ring-shaped. The shapes of the first sub frame adhesive layer 241 and the second sub frame adhesive layer 242 are the same so that the cover 25 and the touch panel 23 can be closely adhered together while avoiding that the second sub frame adhesive layer 242 is misaligned or peeled off during the attaching process.

In the touch display device of the present disclosure, during a panel bonding process, the display panel and the touch panel are adhered by the liquid optical clear adhesive using the full lamination technology. The cover is then adhered to the touch panel by the solid optically clear adhesive using the frame bonding technology to form the vacuum chamber. The cover, the touch panel, and the display panel in the formed touch display device are closely adhered to each other. Therefore, a flatness of a surface of a touch area is better, a sensitivity of touch operation is high, a touch experience is better. Also, an optical adhesive material is effectively saved, a production costs is reduced. It avoids problems such as bonding yellowing, different bending, and wrinkling in a visible area, thereby improving a product yield.

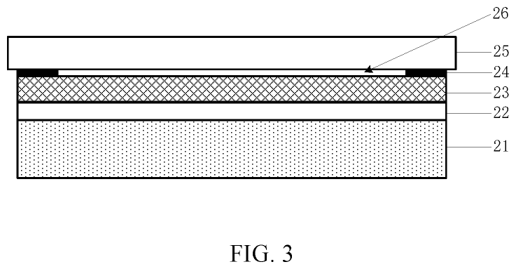

FIG. 3 is a schematic diagram of a layered structure of a touch display device of another embodiment of the present disclosure. The difference from the embodiment shown in FIG. 2 is that, in this embodiment, an adhesive layer 24 is melted and UV-cured by vacuuming and heating. After the frame adhesive layer 24 is melted and leveled, a middle portion of a cover 25 and a middle portion of a touch panel 23 are attached to each other under an action of the atmospheric pressure, a space occupied by a vacuum chamber 26 is compressed to a minimum. The cover 25 and the touch panel 23 are closely adhered to each other, thereby effectively ensuring a sensitivity of touch operations.

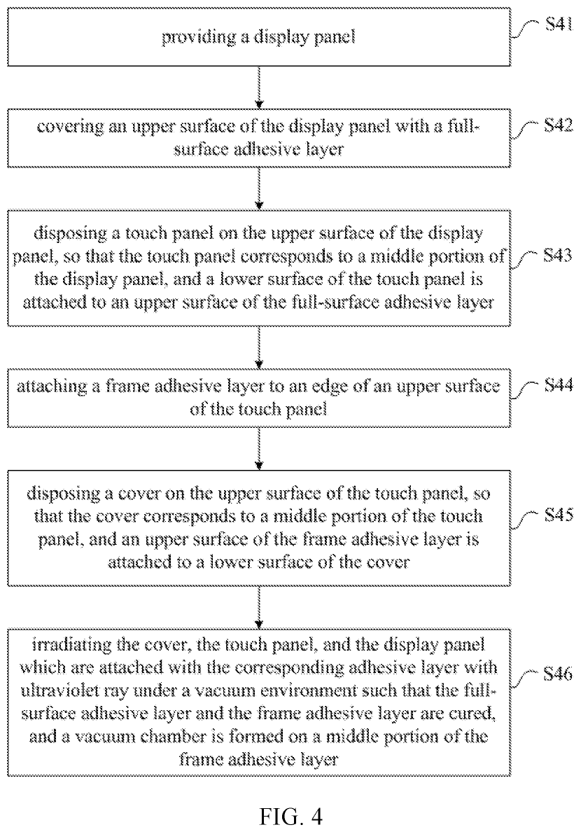

FIG. 4 is a flowchart of a manufacturing method of a touch display device of the present disclosure. The method includes the following steps.

In a step S41, a display panel is provided. The display panel 21 is configured to provide an image for the touch display device.

In a step S42, a full-surface adhesive layer covers an upper surface of the display panel.

In a step S43, a touch panel is disposed on the upper surface of the display panel, so that the touch panel corresponds to a middle portion of the display panel, and a lower surface of the touch panel is attached to an upper surface of the full-surface adhesive layer. A CCD alignment method or a tool-assisted positioning method may be adopted, so that the touch panel 23 corresponds to the middle portion of the display panel 21. In a further embodiment, a shape and size of the touch panel 23 are the same as that of the display panel 21, so that an operation area of the touch panel 23 being consistent with a display area of the display panel 21 can be effectively ensured.

In a further embodiment, the full-surface adhesive layer 22 may be a liquid optical clear adhesive. Since the full-surface adhesive layer 22 uses a liquid optical clear adhesive, and fully covers the upper surface of the display panel 21, the touch panel 23 and the display panel 21 can be bonded by the liquid optical clear adhesive using a full lamination technology. After bonding, a surface of the touch area has better surface flatness, higher sensitivity of touch operation, and better touch experience.

In a step S44, a frame adhesive layer is attached to an edge of an upper surface of the touch panel.

In a step S45, a cover is disposed on the upper surface of the touch panel, so that the cover corresponds to a middle portion of the touch panel, and an upper surface of the frame adhesive layer is attached to a lower surface of the cover. A CCD alignment method or a tool-assisted positioning method may be adopted, so that the cover 25 is disposed opposite to the middle portion of the touch panel 23. The cover 25 is used to protect the touch panel 23 and the display panel 21, and a user can directly perform touch operations on the cover 25. Preferably, a surface area of the cover 25 is larger than a surface area of the touch panel 23, so that the cover 25 can cover a full-surface of the touch panel 23, so that a touch operation performed by the user on the cover 21 has good sensitivity, and it is beneficial to realize narrow bezel design. The cover 25 is preferably a cover glass.

In a further embodiment, the frame adhesive layer 24 may be a solid optically clear adhesive. Because the frame adhesive layer 24 uses a solid optically clear adhesive and is attached to the edge of the upper surface of the touch panel 23, the cover 25 and the touch panel 23 can be bonded by the solid optically clear adhesive using the frame bonding technology. Since a large amount of optical adhesive is required in full lamination technology, the manufacturing cost of the panel is greatly increased. Therefore, the frame bonding technology is adopted between the cover 25 and the touch panel 23 to effectively save the optical adhesive material.

In a step of S46, the cover, the touch panel, and the display panel which are attached with the corresponding adhesive layer are irradiated with ultraviolet ray under a vacuum environment such that the full-surface adhesive layer and the frame adhesive layer are cured, and a vacuum chamber is formed on a middle portion of the frame adhesive layer. The prepared touch display device is shown in FIG. 3.

The cover 25, the touch panel 23, and the display panel 21 which are attached with the corresponding adhesive layer can be transferred into a vacuum apparatus, and then the vacuum apparatus is vacuumed under a sealed environment using a vacuum pump. Then, a heating module in the vacuum apparatus (for example, a heating tube provided in the vacuum apparatus) is used to perform heat treatment on the cover 25, the touch panel 23, and the display panel 21 which are attached with the corresponding adhesive layer, so that the frame adhesive layer 24 employed the solid optically clear adhesive is melted. The frame adhesive layer 24 is melted and leveled under dual effects of heating and pressure, so that the edge of the touch panel 23 and the edge of the cover 25 are closely attached. The middle portion between the touch panel 23 and the cover 25 is a vacuum area surrounded by the frame adhesive layer 24, so that the middle portion between the touch panel 23 and the cover 25 is closely fitted under the action of atmospheric pressure, effectively ensuring the sensitivity of touch operation.

In a further embodiment, the step S44 further includes: 41) attaching a first sub frame adhesive layer to the edge of the upper surface of the touch panel; and 42) cutting a solid optically clear adhesive into an adhesive strip and attaching the adhesive strip to an upper surface of the first sub frame adhesive layer. Correspondingly, the step S45 further includes: 51) heating the cover, the touch panel, and the display panel which are attached with the corresponding adhesive layer under the vacuum environment, so that the adhesive strip is melted; and 52) irradiating the cover, the touch panel, and the display panel which are attached with the corresponding adhesive layer with ultraviolet ray under the vacuum environment such that the full-surface adhesive layer is cured, and the melted adhesive strip is cured into a second sub frame adhesive layer, and the vacuum chamber is formed on middle portions of the first sub frame adhesive layer and the second sub frame adhesive layer.

In a further embodiment, the first sub frame adhesive layer 241 uses an adhesive with high adhesion, and plays a role of pre-fixing and positioning for the second sub frame adhesive layer 242 to prevent the second sub frame adhesive layer 242 from being misaligned. The first sub frame adhesive layer 241 may be a liquid adhesive or a solid adhesive, as long as the second sub frame adhesive layer 242 can be closely attached to the first sub frame adhesive layer 241, and the positions of the second sub frame adhesive layer 242 and the first sub frame adhesive layer 241 can be consistent. Preferably, the first sub frame adhesive layer 241 is an end-to-end connection for subsequent processes, but is not limited thereto, and those skilled in the art can set it according to actual needs.

In a further embodiment, the second sub frame adhesive layer 242 is a solid optically clear adhesive, and a width of the second sub frame adhesive layer 242 is less than or equal to a width of the first sub frame adhesive layer 241, which is convenient for the second sub frame adhesive layer 242 to be attached to the upper surface of the first sub frame adhesive layer 241, and to prevent the second sub frame adhesive layer 242 from being misaligned or peeled off. The step S42 further includes steps of cutting the solid optically clear adhesive into four adhesive strips; connecting the four adhesive strips in end-to-end relation to form a ring-shaped, a rectangular ring-shaped is preferred, but is not limited to; and attaching the ring-shaped adhesive strips to the upper surface of the first sub frame adhesive layer. The solid optically clear adhesive can be cut into a narrow adhesive strip using a knife die cutting method or a laser cutting method, which is conducive to achieving a narrow bezel design.

The shape of the second sub frame adhesive layer 242 is a ring-shaped, so that when the cover 25 and the touch panel 23 are bonded using the frame bonding technology, they can be closely bonded. A shape of the first sub frame adhesive layer 241 is preferably a ring-shaped. The shapes of the first sub frame adhesive layer 241 and the second sub frame adhesive layer 242 are the same so that the cover 25 and the touch panel 23 can be closely adhered together while avoiding that the second sub frame adhesive layer 242 is misaligned or peeled off during the attaching process.

In a further embodiment, the step 51 further includes steps of transferring the cover, the touch panel, and the display panel which are attached with the corresponding adhesive layer to a vacuum apparatus; vacuuming the vacuum apparatus in a sealed environment using a vacuum pump; and heating the cover, the touch panel, and the display panel which are attached with the corresponding adhesive layer using a heating module of the vacuum apparatus, so that the adhesive strip is melted.

In a vacuum environment, the adhesive strip is melted when heated to 60° C. to 80° C. The adhesive strip is melted and leveled under dual effects of heating and pressure, and is mixed with the first sub frame adhesive layer 241, so that the edge of the touch panel 23 and the edge of the cover 25 are closely fitted. In this embodiment, the adhesive strip is melted to form a rectangular ring-shaped, and a middle portion of the rectangular ring-shaped is a vacuum area surrounded by the first sub frame adhesive layer 241 and the second sub frame adhesive layer 242 which is melted and leveled, so that the middle portion between the touch panel 23 and the cover 25 is closely fitted under the action of atmospheric pressure, which effectively ensures the sensitivity of touch operation.

In the touch display device manufactured by the manufacturing method of the present disclosure, during a panel bonding process, the display panel and the touch panel are adhered by the liquid optical clear adhesive using the full lamination technology. The cover is then adhered to the touch panel by the solid optically clear adhesive using the frame bonding technology to form the vacuum chamber. The cover, the touch panel, and the display panel in the formed touch display device are closely adhered to each other. Therefore, a flatness of a surface of a touch area is better, a sensitivity of touch operation is high, a touch experience is better. Also, an optical adhesive material is effectively saved, a production costs is reduced. It avoids problems such as bonding yellowing, different bending, and wrinkling in a visible area, thereby improving a product yield.

It can be understood that for a person of ordinary skill in the art, equivalent replacements or changes can be made according to the technical solution of the present disclosure and its inventive concept, and all these changes or replacements shall fall within the protection scope of the claims appended to the present disclosure.

What is claimed is:

1. A manufacturing method of a touch display device, comprising:
providing a display panel;
covering an upper surface of the display panel with a full-surface adhesive layer, wherein the full-surface adhesive layer comprises a liquid optical clear adhesive;
disposing a touch panel on the upper surface of the display panel, so that the touch panel corresponds to a middle of the display panel, and a lower surface of the touch panel is attached to an upper surface of the full-surface adhesive layer;
attaching a first sub frame adhesive layer to an edge of an upper surface of the touch panel, wherein the first sub frame adhesive layer comprises a liquid adhesive;
cutting a solid optically clear adhesive into an adhesive strip and attaching the adhesive strip to an upper surface of the first sub frame adhesive layer, wherein a width of the adhesive strip is less than a width of the first sub frame adhesive layer;
disposing a cover on the upper surface of the touch panel, so that the cover corresponds to a middle portion of the touch panel, and an upper surface of the adhesive strip is attached to a lower surface of the cover;
heating the cover, the touch panel, and the display panel which are attached with the corresponding adhesive layer under a vacuum environment, so that the adhesive strip is melted; and
irradiating the cover, the touch panel, and the display panel which are attached with the corresponding adhesive layer with ultraviolet ray under the vacuum environment such that the full-surface adhesive layer is cured, and the melted adhesive strip is cured into a second sub frame adhesive layer, and a vacuum chamber is formed on middle portions of the first sub frame adhesive layer and the second sub frame adhesive layer.

2. The manufacturing method as claimed in claim 1, wherein the touch panel and the display panel are adhered by the liquid optical clear adhesive using a full lamination technology.

3. The manufacturing method as claimed in claim 1, wherein the step of cutting the solid optically clear adhesive into the adhesive strip and attaching the adhesive strip to the upper surface of the first sub frame adhesive layer further comprises:
cutting the solid optically clear adhesive into four adhesive strips;
connecting the four adhesive strips in end-to-end relation to form a ring-shaped; and
attaching the ring-shaped adhesive strips to the upper surface of the first sub frame adhesive layer.

4. The manufacturing method as claimed in claim 1, wherein the step of heating the cover, the touch panel, and the display panel which are attached with the corresponding adhesive layer under the vacuum environment, so that the adhesive strip is melted, further comprises:
transferring the cover, the touch panel, and the display panel which are attached with the corresponding adhesive layer to a vacuum apparatus;
vacuuming the vacuum apparatus in a sealed environment using a vacuum pump; and
heating the cover, the touch panel, and the display panel which are attached with the corresponding adhesive layer using a heating module of the vacuum apparatus, so that the adhesive strip is melted.

5. The manufacturing method as claimed in claim 1, wherein a width of the second sub frame adhesive layer is less than or equal to a width of the first sub frame adhesive layer.

6. The manufacturing method as claimed in claim 1, wherein a shape of the touch panel is the same as a shape of the display panel, and a size of the touch panel is the same as a size of the display panel.

7. A touch display device, comprising:
a display panel;
a full-surface adhesive layer covering an upper surface of the display panel;
a touch panel attached to an upper surface of the full-surface adhesive layer, wherein the touch panel corresponds to a middle portion of the display panel;
a frame adhesive layer attached to an edge of an upper surface of the touch panel;
a vacuum chamber formed on a middle portion of the frame adhesive layer; and
a cover attached to an upper surface of the frame adhesive layer, wherein the cover corresponds to a middle portion of the touch panel.

8. The touch display device as claimed in claim 7, wherein the full-surface adhesive layer comprises a liquid optical clear adhesive, and the touch panel and the display panel are adhered by the liquid optical clear adhesive using a full lamination technology; and
the frame adhesive layer comprises a solid optically clear adhesive, and the cover and the touch panel are adhered by the solid optically clear adhesive using a frame bonding technology.

9. The touch display device as claimed in claim 7, wherein the frame adhesive layer comprises:
a first sub frame adhesive layer attached to the edge of the upper surface of the touch panel; and
a second sub frame adhesive layer attached to an upper surface of the first sub frame adhesive layer, wherein the vacuum chamber is formed on middle portions of the first sub frame adhesive layer and the second sub frame adhesive layer.

10. The touch display device as claimed in claim 9, wherein the first sub frame adhesive layer comprises a liquid adhesive or a solid adhesive; and
the second sub frame adhesive layer comprises a solid optically clear adhesive, and a width of the second sub frame adhesive layer is less than or equal to a width of the first sub frame adhesive layer.

11. The touch display device as claimed in claim 9, wherein a shape of the second sub frame adhesive layer comprises a ring-shaped.

12. The touch display device as claimed in claim 7, wherein a shape of the touch panel is the same as a shape of the display panel, and a size of the touch panel is the same as a size of the display panel.

13. A manufacturing method of a touch display device, comprising:
providing a display panel;
covering an upper surface of the display panel with a full-surface adhesive layer;
disposing a touch panel on the upper surface of the display panel, so that the touch panel corresponds to a middle portion of the display panel, and a lower surface of the touch panel is attached to an upper surface of the full-surface adhesive layer;
attaching a frame adhesive layer to an edge of an upper surface of the touch panel;
disposing a cover on the upper surface of the touch panel, so that the cover corresponds to a middle portion of the touch panel, and an upper surface of the frame adhesive layer is attached to a lower surface of the cover; and
irradiating the cover, the touch panel, and the display panel which are attached with the corresponding adhesive layer with ultraviolet ray under a vacuum environment such that the full-surface adhesive layer and the frame adhesive layer are cured, and a vacuum chamber is formed on a middle portion of the frame adhesive layer.

14. The manufacturing method as claimed in claim 13, wherein the full-surface adhesive layer comprises a liquid optical clear adhesive, and the touch panel and the display panel are adhered by the liquid optical clear adhesive using a full lamination technology; and
the frame adhesive layer comprises a solid optically clear adhesive, and the cover and the touch panel are adhered by the solid optically clear adhesive using frame bonding technology.

15. The manufacturing method as claimed in claim 13, wherein the step of attaching the frame adhesive layer to the edge of the upper surface of the touch panel comprises:
attaching a first sub frame adhesive layer to the edge of the upper surface of the touch panel, cutting a solid optically clear adhesive into an adhesive strip, and attaching the adhesive strip to an upper surface of the first sub frame adhesive layer; and
the steps of irradiating the cover, the touch panel, and the display panel which are attached with the corresponding adhesive layer with ultraviolet ray under the vacuum environment such that the full-surface adhesive layer and the frame adhesive layer are cured, and the vacuum chamber is formed on the middle portion of the frame adhesive layer, further comprises:
heating the cover, the touch panel, and the display panel which are attached with the corresponding adhesive layer under the vacuum environment, so that the adhesive strip is melted; and irradiating the cover, the touch panel, and the display panel which are attached with the corresponding adhesive layer with ultraviolet ray under the vacuum environment such that the full-surface adhesive layer is cured, and the melted adhesive strip is cured into a second sub frame adhesive layer, and the vacuum chamber is formed on middle portions of the first sub frame adhesive layer and the second sub frame adhesive layer.

16. The manufacturing method as claimed in claim 15, wherein the steps of cutting the solid optically clear adhesive into an adhesive strip, and attaching the adhesive strip to the upper surface of the first sub frame adhesive layer further comprises:
cutting the solid optically clear adhesive into four adhesive strips;
connecting the four adhesive strips in end-to-end relation to form a ring-shaped; and
attaching the ring-shaped adhesive strips to the upper surface of the first sub frame adhesive layer.

17. The manufacturing method as claimed in claim 15, wherein the step of heating the cover, the touch panel, and the display panel which are attached with the corresponding adhesive layer under the vacuum environment, so that the adhesive strip is melted, further comprises:
transferring the cover, the touch panel, and the display panel which are attached with the corresponding adhesive layer to a vacuum apparatus;
vacuuming the vacuum apparatus in a sealed environment using a vacuum pump; and
heating the cover, the touch panel, and the display panel which are attached with the corresponding adhesive layer using a heating module of the vacuum apparatus, so that the adhesive strip is melted.

18. The manufacturing method as claimed in claim 15, wherein the first sub frame adhesive layer comprises a liquid adhesive or a solid adhesive, and a width of the second sub frame adhesive layer is less than or equal to a width of the first sub frame adhesive layer.
